(19) United States
(12) Patent Application Publication
(10) Pub. No.: US 2025/0377133 A1
(43) Pub. Date: Dec. 11, 2025

(54) SILENCER FOR AN AIR-CONDITIONING AND/OR VENTILATION SYSTEM

(71) Applicant: VIESSMANN HOLDING INTERNATIONAL GMBH, Allendorf (Eder) (DE)

(72) Inventors: Max ROHN, Mülheim an der Ruhr (DE); Sebastian HECKER, Sursee (CH); Thomas HANZ, Rennerod (DE)

(73) Assignee: VIESSMANN HOLDING INTERNATIONAL GMBH, Allendorf (Eder) (DE)

(21) Appl. No.: 19/231,060

(22) Filed: Jun. 6, 2025

(30) Foreign Application Priority Data
Jun. 7, 2024 (EP) 24180943.3

(51) Int. Cl. F24F 13/24

(52) U.S. Cl. CPC F24F 13/24; F24F 2013/242

(57) ABSTRACT

A silencer for an air-conditioning and/or ventilation system has an inlet, an outlet, a central air channel which is arranged therebetween, a first sound-absorbing cover and a first sound-proofing outer shell. The first sound-absorbing cover surrounds the central air channel in a first portion of the silencer and the first outer shell surrounds the first sound-absorbing cover. A second outer shell surrounds the central air channel in a second portion of the silencer, wherein the second portion is arranged downstream of the first portion in the flow direction or the first portion is arranged downstream of the second portion in the flow direction. The second outer shell has lower sound-proofing than the first outer shell. The silencer can be configured in a compact manner and it enables propagation of the sound into an environment in which the sound does not have a disruptive effect.

### CROSS-REFERENCE TO RELATED APPLICATIONS

This application claims priority based on European Patent Application No. 24180943.3 filed Jun. 7, 2024, the entire contents of which are incorporated herein by reference.

### TECHNICAL FIELD

The present invention relates to a silencer for an air-conditioning and/or ventilation system, a unit of an air-conditioning and/or ventilation system having a silencer and a method for sound-damping an air-conditioning and/or ventilation system.

### PRIOR ART

Within air-conditioning and/or ventilation systems, noise emissions occur as a result of the air flow propagating in the air lines. The sound is caused by fans of the air-conditioning and/or ventilation devices and the air which flows through the air lines, which, on the one hand, generates a noise and which, on the other hand, transmits noise from one room of a building to another room of the building.

In order to reduce these noise emissions, silencers are therefore used in the air lines.

### SUMMARY OF THE INVENTION

An object of the invention is to provide an improved silencer for an air-conditioning and/or ventilation system.

The silencer according to the invention for an air-conditioning and/or ventilation system has an inlet, an outlet, a central air channel, a first sound-absorbing cover and a first outer shell. The air channel is arranged between the inlet and the outlet and defines a flow direction between the inlet and outlet. The first sound-absorbing cover surrounds the central air channel in a first portion of the silencer and the first outer shell surrounds the first sound-absorbing cover. The first outer shell is sound-proofing. A second outer shell which surrounds the central air channel in a second portion of the silencer is provided. The second outer shell has lower sound-proofing than the first outer shell. The second portion is arranged downstream of the first portion in the flow direction or the first portion is arranged downstream of the second portion in the flow direction.

Preferably, the first portion is located adjacent to the sound source, in particular with respect to the air-conditioning and ventilation device of the system. This arrangement is independent of whether air flows from the device into the silencer and an air line or is directed from an air line through the silencer into the device. The second portion is located accordingly remote from or adjacent to the device.

The term “sound-proofing” means that the sound propagation is interrupted or reduced. The term “sound-absorbing” means that the air-borne sound is absorbed and converted into heat, that is to say, it is damped.

The term “insertion loss” is the weakening of the sound when passing through a transmission system, for example through a pipe or another component.

The silencer according to the invention has not only sound-damping properties, but also sound-proofing properties, wherein it has in the flow direction at least two regions or portions with different sound-proofing properties. In the first portion, the sound is absorbed and a sound propagation into the environment is prevented as far as possible. In the second portion, sound can be propagated into the environment such that the sound propagation in the air line of the air-conditioning and/or ventilation system is reduced or even minimized.

The silencer according to the invention is a combination of portions with different sound-proofing properties. The silencer can preferably be arranged with one portion closer to a sound source than with another portion. The silencer preferably has sound-absorbing and sound-proofing properties. The silencer preferably has different properties in the flow direction. Preferably, at least two regions which can be clearly distinguished from each other and have different sound-proofing properties are provided. These at least two regions or portions may have the same sound-absorbing properties or they may have different such properties.

As a result of these at least two regions or portions, the silencer according to the invention has a high insertion loss for a short structural length. The silencer has a compact structure and accordingly requires little structural space.

It is advantageous that the sound can be distributed in a room of the building in which it does not have a disruptive effect. Preferably, the sound is directed via the second portion of the silencer into the same room in which the sound-generating air-conditioning or ventilation device is located. This room is generally known as the installation room.

As a result of the first sound-absorbing cover which is arranged adjacent to the sound source, in particular to the sound-generating air-conditioning and/or ventilation device, the silencer can be configured in such a manner that the sound immision in the installation room is not significantly increased. Consequently, the sound directed into the other rooms is minimized and in the installation room the acoustic load is nonetheless not significantly increased. The sound immision into office spaces and living spaces is consequently minimized.

It is further advantageous for the free cross section, through which air can flow, of the central air channel to be maintained, that is to say, not to have to narrow or accommodate chicanes. A pressure loss is thereby prevented and the flow properties of the air-conditioning and/or ventilation system are optimized.

The different sound-proofing can, for example, be maintained by selecting a suitable material of the first and second outer shell. In particular, by selecting the density or mass of the material. The smaller the density or the mass of the material is, the lower the sound-proofing generally is. The first and second outer shells are, for example, aluminium flexible pipes, preferably with different wall thicknesses. For example, aluminium foil or plastics sheeting or a combination of materials is also suitable as a material. For example, the first portion is an aluminium flexible pipe and an aluminium foil is used for the second portion. In some embodiments, in the first and/or in the second outer shell a wire is introduced in order to ensure or at least increase the stability of the silencer.

The sound-absorbing cover is preferably a porous absorber, for example made of rock wool, mineral wool or melamine resin foam.

The second outer shell consequently enables sound propagation outwards. Preferably, the sound-proofing of the second outer shell enables sound propagation from the central air channel into an external environment of the silencer.

The silencer may have different forms. Preferably, it is tubular. Preferably, it is a duct silencer. Preferably, the central air channel thereof has a round cross section. However, other forms, for example a rectangular cross section, are also possible.

Preferably, the silencer can be integrated in an air line of the air-conditioning and/or ventilation system, wherein it is preferably replaceably arranged in the air line. Preferably, the inlet and the outlet are in the form of connecting sockets for installation in the air line. The inlet and the outlet can alternatively or additionally be directly connected to an air-conditioning and ventilation device of the system.

Preferably, the second portion is directly or approximately adjacent to the first portion. This improves the compact construction and enables sound optimization.

The silencer preferably has an inner wall which forms the central air channel. In one embodiment, this wall is formed by the sound-absorbing material of the at least one sound-absorbing cover. In other embodiments, a correspondingly curved grid is provided. In further embodiments, a grid or an inner pipe with sound-permeable walls which forms the central air channel is provided.

The central air channel is surrounded at least in the first portion of the silencer by a sound-absorbing material or a sound-absorbing unit, that is to say by a sound-absorbing cover. In some embodiments, the central air channel is not surrounded by any sound-absorbing cover in the second portion. Preferably, the central air channel is surrounded in the second portion in these embodiments exclusively by the second outer shell. In other embodiments, however, the central air channel is surrounded in the second portion by the sound-absorbing cover. This maximizes the sound absorption, that is to say the sound damping.

If precisely two portions are provided, a correct installation direction of the silencer in the air line must be ensured. The silencer is preferably labelled appropriately. Preferably, the silencer is orientated in such a manner that the first portion is closer to the sound source than the second portion. This construction has the advantage that it can be configured to be very compact and short and consequently requires little space in the air line. Preferably, the first portion is configured to be longer than the second portion. The silencer can be configured in an extremely compact manner.

In one embodiment, a third outer shell which surrounds the central air channel in a third portion of the silencer is provided. The second portion is arranged between the first portion and the third portion. The third outer shell has greater sound-proofing than the second outer shell. This embodiment has the advantage that, as a result of its longer configuration, it has an increased sound reduction, particularly when the central air channel is surrounded in the third portion by a sound-absorbing cover. Another advantage is that the silencer can be installed in a direction-independent manner in the air line or with respect to the sound-generating air-conditioning and ventilation device, particularly when the sound-proofing action of the first and third outer shell is identical or approximately identical.

The silencer is preferably flexible, that is to say bendable and/or expandable. In other embodiments, it is stiff or even rigid over a portion, in particular over the first portion, or over its entire length.

The unit according to the invention of an air-conditioning and/or ventilation system of a building has a sound-generating air-conditioning and/or ventilation device, at least one air line which is connected to the air-conditioning and/or ventilation device and the silencer according to the invention. The silencer is arranged in the air line and adjacent to the air-conditioning and/or ventilation device. The unit is configured for arrangement in a room of the building so that sound which reaches the outer side from the second portion of the silencer propagates in this room. The sound immision into adjacent rooms, in particular into living or office spaces, is thereby minimized.

The silencer according to the invention can be installed at any locations of the air line. It can be connected to in principle all connections of the air-conditioning and/or ventilation devices. However, the arrangement on sections which open into an office or living space, for example into a supply air line or an exhaust air line and/or at the pressure side of the devices, for example in the supply air line and the outgoing air line is preferred. However, they can also be arranged in the external air line. The first portion of the silencer in each case preferably faces the sound source, the second portion is located on the side of the silencer remote from the sound source.

Air-conditioning and/or ventilation devices are, for example, a counter-current heat exchanger with at least one fan or filter.

The method according to the invention for sound-damping an air-conditioning and/or ventilation system uses at least one silencer, preferably at least one silencer according to the invention. Air from a sound-generating air-conditioning and/or ventilation device is guided into the silencer and into an air line or air is guided from an air line and the silencer into the sound-generating air-conditioning and/or ventilation device. In a first portion or region of the silencer facing the air-conditioning and/or ventilation device, sound is both absorbed and sound-proofed. In a second region of the silencer facing away from the air-conditioning and/or ventilation device, the sound is less sound-proofed than in the first region so that, in this region, it can reach an external environment of the silencer through a shell of the silencer. The sound can thereby be directed in a selective manner into a room or an environment in which it does not have a disruptive effect. Furthermore, sound can be directed in a selective manner into the room or the environment to an extent such that it does not have a disruptive effect there. The sound-proofing is preferably carried out via the shell to the environment. Preferably, the silencer is orientated based on the position of the air-conditioning and/or ventilation device, wherein the first portion is arranged independently of the flow direction of the air closer to the device than the second portion of the silencer.

Preferably, the silencer is configured in such a manner that it substantially absorbs flow sounds, that is to say sound which is produced in the air line and sound which is produced by the sound-generating air-conditioning and/or ventilation device can be substantially propagated into the environment.

Preferably, the silencer is arranged in the same room of a building as the sound-generating air-conditioning and/or ventilation device. It is preferably arranged as close as possible to the device.

Depending on the embodiment, the sound-proofing shells also have sound-damping properties and/or the sound-absorbing covers also have sound-proofing properties. However, the properties are such that, in the second portion, sound propagation is enabled over the circumference, wherein it is greater than in the first portion. In addition, the sound-proofing action of the sound-absorbing covers is preferably significantly less than the sound-absorbing action thereof and preferably less than the sound-proofing action of the sound-proofing shells.

### BRIEF DESCRIPTION OF THE DRAWINGS

Preferred embodiments of the invention are described in the following with reference to the drawings, which are merely used for the purpose of explanation and are not to be designed in a limited manner. In the drawings,

FIG. 1 shows an exemplary illustration of an air-conditioning and/or ventilation device of an air-conditioning and/or ventilation system having a silencer according to the invention;

FIG. 2 shows a perspective, schematic illustration of a silencer according to the invention according to a first embodiment;

FIG. 3 shows a side view of the silencer according to FIG. 2;

FIG. 4 shows a longitudinal section along C-C through the silencer according to FIG. 3;

FIG. 5 shows a cross section along A-A through the silencer according to FIG. 3;

FIG. 6 shows a cross section along B-B through the silencer according to FIG. 3;

FIG. 7 shows a perspective, schematic illustration of a silencer according to the invention according to a second embodiment;

FIG. 8 shows a longitudinal section through the silencer according to FIG. 7;

FIG. 9 shows a perspective, schematic illustration of a silencer according to the invention according to a third embodiment and

FIG. 10 shows a longitudinal section through the silencer according to FIG. 9.

Components which are identical or similar are given the same reference signs.

### DESCRIPTION OF PREFERRED EMBODIMENTS

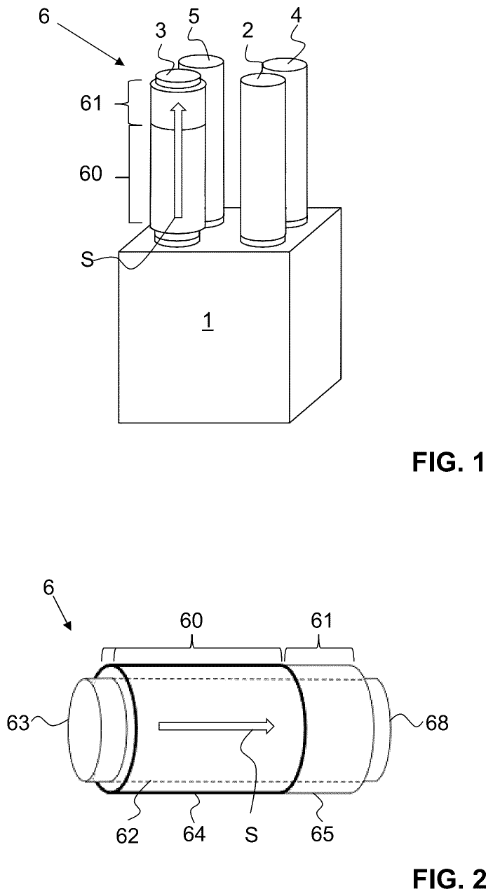

In FIG. 1 to represent other air-conditioning and/or ventilation devices, a counter-current heat exchanger 1 is illustrated. Such heat exchangers are known in the prior art. They have a connection for an external air line 2 which guides external air from the outer side through a building wall and through the heat exchanger 1 into a supply air line 3. The supply air line 3 guides the air which is thus drawn in from the outer side into an interior room of a building, preferably into an office or living space. An exhaust air line 4 leads from the interior room through a building wall and through the heat exchanger 1 into an outgoing air line 5 in order to guide air drawn in from the interior room outwards.

The at least one fan inside the heat exchanger 1 produces sound which propagates through the lines 2, 3, 4, 5 and also reaches through the housing of the heat exchanger into the installation room, in which the heat exchanger 1 is arranged.

FIG. 1 shows an arrangement in a sound laboratory. Generally, the lines 2, 3, 4, 5 do not all lead through the same wall, in contrast to the arrangement shown here.

As can be seen in FIG. 1, a silencer 6 is arranged in the supply air line 3. It is interposed adjacent to the connection of the supply air line 3 to the heat exchanger 1. It is preferably configured in a tubular manner. Preferably, it is flexible and can be extended and compressed in the longitudinal direction thereof in order to adapt to the path of the supply air line 3. The flow direction of the air through the supply air line 3 and consequently through the silencer is illustrated in FIG. 1 with an arrow and provided with the reference sign S.

The silencer 6 has two regions or portions. A first portion has the reference sign 60, a second portion which follows in the flow direction S has the reference sign 61. Preferably, the second portion 61 directly adjoins the first portion 60.

Silencers 6 which are constructed in an identical manner may additionally or alternatively also be arranged in one of the other lines 3, 4, 5. Preferably, they are also arranged adjacent to the heat exchanger 1, more specifically to the corresponding connections of the heat exchanger 1. The arrangement is preferably independent of the flow direction; instead it is determined by the orientation with respect to the sound source, that is to say in this instance the sound-generating heat exchanger 1. The first portion 60 is preferably arranged adjacent to the sound source, the second portion is arranged further away. In the example according to FIG. 1, silencers for the additional lines 3, 4, 5 would consequently be orientated in the same manner as the silencer 6 which is illustrated and belongs to the line 3.

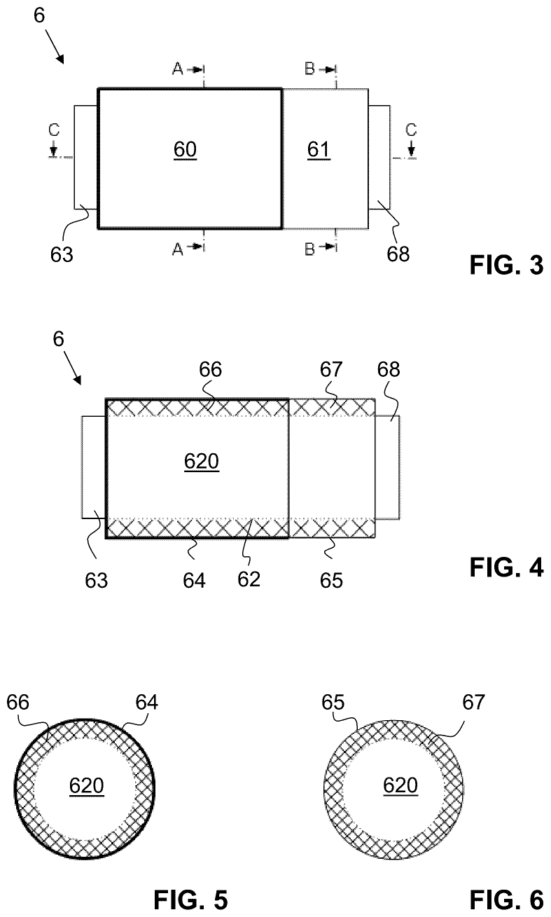

In FIGS. 2 to 6, a first exemplary embodiment of such a silencer 6 is illustrated schematically. It has an inlet 63 and an outlet 68 which are preferably in the form of connecting sockets for connecting to the pipes or channels of the air line. A central air channel 620 with a circumferential inner wall 62 is formed between them. Air flows through the central air channel 620 and forms the connection member between the air line portions. The inlet 63 and the outlet 68 define the flow direction S.

The first portion 60 is formed upstream and the second portion 61 is formed downstream.

They also preferably adjoin each other in this example.

The central air channel 620 is formed by an inner pipe or by a grid, by a sound-absorbing cover or by another supporting apparatus which surrounds the central air channel 620. In the example illustrated, a sound-absorbing cover 66, 67 which preferably has a supporting structure extends over the entire length of the first portion 60 and also over the entire length of the second portion 61.

If the inner wall 62 of the air channel 620 is formed by an inner pipe, a grid or another structure, it is surrounded at least in the first portion 60 of the silencer by a first sound-absorbing cover 66. In this example, the central air channel 620 is surrounded in a second portion 61 of the silencer by a second sound-absorbing cover 67. The first and second sound-absorbing cover 66, 67 are depending on the embodiment configured together in one piece or are mutually separate components. Depending on the embodiment, they have the same sound-absorbing action or mutually different sound-absorbing actions. The first and second sound-absorbing cover 66, 67, that is to say the porous absorber, is preferably produced from a wound mat made of rock wool, mineral wool or melamine resin foam.

The first sound-absorbing cover 66 is surrounded by a first outer shell 64. It has a sound-proofing action. The sound reduction index R is preferably greater than 25 dB. The sound reduction index R is produced from the inner sound power minus the outer sound power. Preferably, the first outer shell 64 is produced from an aluminium flexible pipe, from an aluminium foil, from a plastics sheeting or a fabric. In some embodiments, a wire or a supporting fabric is incorporated into the first outer shell 64.

The second sound-absorbing cover 67 is surrounded by a second outer shell 65. It has a sound-proofing action which is less than the sound-proofing action of the first outer shell 64. Preferably, it is more than 10 dB lower than that of the first outer shell 64. Its sound reduction index R is preferably less than 15 dB. Preferably, the second outer shell 64 is produced from an aluminium flexible pipe, from an aluminium foil, a plastics sheeting or a fabric. In some embodiments, a wire or a supporting fabric is incorporated into the second outer shell 65. If it is produced from the same material as the first outer shell 64, the wall thickness thereof is thus preferably selected to be smaller or it has sound passage openings.

Sound which reaches the silencer 6 from the heat exchanger 1 through the supply air line 3 or is generated in the supply air line 3 is partially damped, that is to say absorbed, in the first portion 60 and directed onwards into the second portion 61. Preferably, the first portion 60 has such high sound-proofing that hardly any sound can reach the outer side via the circumference thereof. Sound which reaches the environment should not significantly increase the overall noise in the room. Preferably, the sound which reaches the outer side via the circumference should be below 6 dB of the device noise. In the second portion 61, the sound is further partially absorbed, wherein it can now partially reach the outer side via the circumference of the second portion 61.

If the unit, formed by a sound-generating device, for example a heat exchanger 1, supply air line 3 and silencer 6, is arranged in the same room, the sound which propagates via the circumference of the silencer 6 reaches this room. In this room, the at least one fan of the heat exchanger 1 is in any case audible. If the sound immision caused by the silencer 6 into this room is only a small percentage in comparison with the sound immision by the heat exchanger 1, this additional sound does not have a disruptive effect. However, it reduces the load on the adjacent living and office spaces in which noise is perceived in a significantly more sensitive manner.

Preferably, the noise emission of the device 1 and the sound emission of the silencer are determined and the silencer is configured accordingly so that the overall sound power in the installation room does not increase or increases only insignificantly. An increase of approximately 2 dB does not have a disruptive effect.

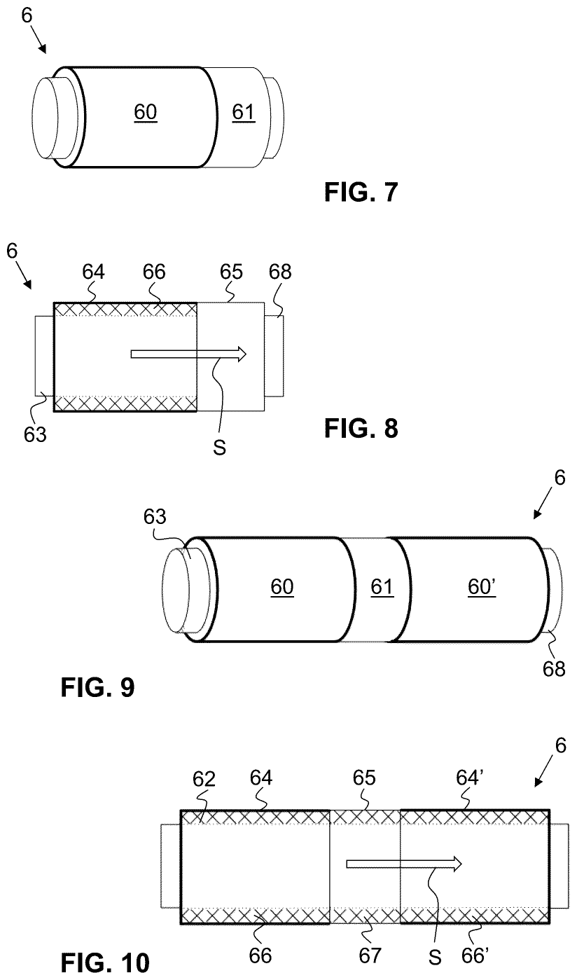

FIGS. 7 and 8 illustrate a second exemplary embodiment of the silencer 6 according to the invention. It is configured in an identical manner to the exemplary embodiment according to FIGS. 2 to 6 with the exception of the difference that the second portion 61 does not have any second sound-absorbing cover.

FIGS. 9 and 10 illustrate a third exemplary embodiment of the silencer 6 according to the invention. It is configured in a substantially identical manner to the exemplary embodiment according to FIGS. 2 to 6. However, it has a third portion 60′ which is arranged following the second portion 61 in the flow direction S, preferably directly adjacent.

The third portion 60′ has a sound-proofing outer shell 64′. It preferably has the same sound-proofing properties as the first outer shell 64. Preferably, the sound-damping properties of a third sound-absorbing cover 66′ which surrounds the central air channel 620 in the third portion 60′ are also the same as those of the first sound-absorbing cover 66. Consequently, the silencer 6 can also be used in the opposite direction.

In this example, the central air channel 620 is again surrounded in the second portion 61 of the silencer by a second sound-absorbing cover 67. However, it may also not have any such cover and, for example, be configured as in the second exemplary embodiment.

As can be seen in the figures of the three exemplary embodiments, the second portion 61 is in each case shorter than the first or third portion 60, 60′. This is preferred. However, it may also be configured to be of the same length or longer.

Preferably, the central air channel 620 has the same inner diameter in all portions 60, 60′, 61. Preferably, it is also consistent within the respective portions 60, 60′, 61. The outer diameter of the portions 60, 60′, 61 is also preferably of the same size and consistent over the length. Depending on the type and shape of the respective sound-absorbing covers 66, 66′, 67, however, it may also be of a different size.

The sound-proofing shells 64, 64′, 65 preferably form the outer surface of the silencer 6.

The silencer according to the invention can be configured in a compact manner and it enables over the surface of the second cover a transmission of the sound into an environment in which the sound does not have a disruptive effect.

1. A silencer for an air-conditioning and/or ventilation system, wherein the silencer has
an inlet,
an outlet,
a central air channel which is arranged between the inlet and the outlet and which defines a flow direction between the inlet and outlet,
a first sound-absorbing cover which surrounds the central air channel in a first portion of the silencer, and
a first outer shell which surrounds the first sound-absorbing cover and is sound-proofing,
wherein a second outer shell which surrounds the central air channel in a second portion of the silencer is provided, and
wherein the second outer shell has lower sound-proofing than the first outer shell,
wherein the second portion is arranged downstream of the first portion in the flow direction or
wherein the first portion is arranged downstream of the second portion in the flow direction.

2. The silencer according to claim 1, wherein the sound-proofing of the second outer shell enables sound propagation from the central air channel into an external environment of the silencer.

3. The silencer according to claim 1, wherein the silencer is tubular.

4. The silencer according to claim 1, wherein the inlet and the outlet are in the form of connecting sockets for installation in an air line or for connection to a sound-generating air-conditioning and/or ventilation device.

5. The silencer according to claim 1, wherein the second portion is directly adjacent to the first portion.

6. The silencer according to claim 1, wherein a grid or an inner pipe which forms the central air channel is provided.

7. The silencer according to claim 1, wherein no sound-absorbing cover is provided in the second portion.

8. The silencer according to claim 1, wherein the central air channel is surrounded exclusively in the second portion by the second outer shell.

9. The silencer according to claim 1, wherein the central air channel is surrounded in the second portion by a second sound-absorbing cover.

10. The silencer according to claim 1, wherein a third outer shell which surrounds the central air channel in a third portion of the silencer is provided, wherein the second portion is arranged between the first portion and the third portion, and wherein the third outer shell has greater sound-proofing than the second outer shell.

11. The silencer according to claim 10, wherein the third outer shell has the same sound-proofing as the first outer shell.

12. A unit of an air-conditioning and/or ventilation system of a building, wherein the unit has
a sound-generating air-conditioning and/or ventilation device,
at least one air line which is connected to the air-conditioning and/or ventilation device and
the silencer according to claim 1,
wherein the silencer is arranged in the air line and adjacent to the air-conditioning and/or ventilation device and
wherein the unit is configured for arrangement in a room of the building so that sound which reaches the outer side from the second portion of the silencer propagates in this room.

13. A method for sound-damping an air-conditioning and/or ventilation system using at least one silencer, preferably by means of at least one silencer according to claim 1,
wherein air from a sound-generating air-conditioning and/or ventilation device is guided into the silencer and into an air line which is connected to the silencer, or wherein air is guided from an air line and the silencer into the sound-generating air-conditioning and/or ventilation device,
wherein, in a first portion of the silencer facing the sound-generating air-conditioning and/or ventilation device, sound is absorbed and sound-proofed and, in a second portion of the silencer facing away from the air-conditioning and/or ventilation device, the sound is less sound-proofed so that, in this region, it can reach an external environment of the silencer.

14. The method according to claim 13, wherein the silencer is configured in such a manner that it substantially absorbs sound which is produced in the air line and sound which is produced by the sound-generating air-conditioning and/or ventilation device can be substantially propagated into the environment.

15. The method according to claim 13, wherein the silencer is arranged in the same room of a building as the sound-generating air-conditioning and/or ventilation device.

16. The silencer according to claim 1, wherein the first portion is longer than the second portion.
